(19) United States
(12) Patent Application Publication
(10) Pub. No.: US 2005/0138046 A1
(43) Pub. Date: Jun. 23, 2005

(54) Method for ensuring the integrity of a data record set

(75) Inventors: Markus Miettinen, Helsinki (FI); Kimmo Hatonen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/779,759

(22) Filed: Feb. 18, 2004

(30) Foreign Application Priority Data
Dec. 18, 2003 (FI) 20031856

(51) Int. Cl. G06F 7/00

(52) U.S. Cl. 707/100

(57) ABSTRACT

The invention discloses a method, a system and a computer program for storing data on a database in a manner that the integrity and authenticity of the database can be verified later. According to the invention a data record is signed with a checksum that is computed from the previous checksum, the data record to be stored and a storage key.

### FIELD OF THE INVENTION

The invention relates to a method, system and computer program for ensuring the integrity of data record set stored on a database or a similar information storage.

### BACKGROUND OF THE INVENTION

Many computerized applications produce huge amounts of data to be stored. Typically events of the computerized applications are logged into a log file. The log files are one of the most important sources of information for system operators, software developers, security personnel and various other groups.

Traditionally log data files are written in a sequential manner into the log file. The basic elements of most types of the log files are log records that are often represented as rows in a log file. It is very important that the structure and contents of a log file remain authentic. Especially for security monitoring it is important that the rows may not be modified or deleted in any way without administrator noticing made changes.

Well-known methods for ensuring the integrity of a log file exist already today. For example, message authentication codes (MAC) or digital signatures can be used to associate a cryptographical code with each log file. Later unauthorized modifications can be detected because the digital signature or authentication code changes, if the contents of the file change. However, these kinds of methods do not protect the integrity before the digital signature or another kind of authentication code is assigned to the file to be protected.

However, in many applications the amount of data needed to be stored is huge. Thus, there is a need for storing log data or similar data to a relational database. There the question of integrity protection is somewhat different. In relational databases data is stored in tables consisting of tuples of attributes, so called records. Typically log entries are stored on a database so that each log row corresponds to a record of a particular database table.

Integrity protection in relational databases relies traditionally on restricting the access rights of the users of the database so that unauthorized users may not alter the contents of the database. Access control is enforced by the relational database management system (RDBMS). Another way of ensuring the integrity of a database is to save it to a disk file and to attach a cryptographic code to it as described above.

This approach is often impractical as many database tables are dynamic by their nature and have to be updated very often. In a log database, for instance, log entries generated during a day have to be inserted into the corresponding database table all the time as the amount of the data to be stored may be huge, as in bank transactions. Freezing the database table's contents and protecting its integrity with a cryptographic checksum is only then useful, when one can be sure that the contents of a table will not have to be updated anymore. In a log database this means that one has to use per-day database tables for storing the information. One drawback of such a solution is that queries, which access several days' data, have to make several table lookups to execute a query.

U.S. Pat. No. 5,978,475 (Schneier et al.) discloses a method for verifying the integrity of a log file. However, the aforementioned patent does not disclose any means for arranging the data on a database in which the administrator has full capabilities to modify the data in data records.

A major deficiency of traditional solutions is also that they cannot be applied in a setting, where a database system is used and the database administrator cannot be entirely trusted. In most RDBM systems the database administrator (DBA) has close to unlimited authorizations to modify the database and its contents. Any data that is inserted into the database may be modified by a malicious administrator even before the data is cryptographically protected from unauthorized modifications.

A major drawback of the prior art is the problem of controlling access rights to the database. A further drawback is that the data cannot be stored on files to be digitally signed as the files change all the time. A third major drawback is that the database administrator must be trusted. Nowadays the administrator is typically a technician who actually would not even need to know the information stored on a database. Thus, there is a need for a method, which allows a plurality of people to view and check the integrity of the contents of a database while having access rights for storing data to the database.

### SUMMARY OF THE INVENTION

The invention discloses a method for ensuring data integrity in database systems. The invention discloses a solution for having publicly viewable databases with publicly available integrity checksums that can be used for integrity verification. According to the present invention the integrity checksum is computed with a cryptographic method from the data to be stored, a checksum of the previous record and a storage key. The storage key is issued only to entities that have a permission to sign the data on the database. A signing entity may and should be different from the database administrator. One solution is to use public key cryptography in which the signing entity calculates an integrity checksum with his/her private key and people willing to verify the integrity may use his/her public key for verification. The calculated integrity checksum is then attached to the data record. The first record may be a generated initial record or it may harness a previously agreed previous checksum that is needed to compute its own checksum. In the verification the integrity checksum is computed similarly and compared to the previously computed checksum attached to the specific data record.

The benefit of the invention is to allow an authentic database with integrity checks. With the method according to the invention the database can be signed so that only the signing authority may change the contents of the database. According to the invention data records stored on a database may not be deleted or altered in any way without breaking the chain of computed integrity checksums.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart illustrating the basic principle of integrity verification according to the invention,

FIG. 2 is a flow chart illustrating one embodiment of storing a data record according to the invention,

FIG. 3 is a block diagram illustrating an embodiment of the system according to presented in FIG. 2.

### DETAILED DESCRIPTION OF THE INVENTION

Reference will now be made in detail to the embodiments of the present invention, examples of which are illustrated in the accompanying drawings.

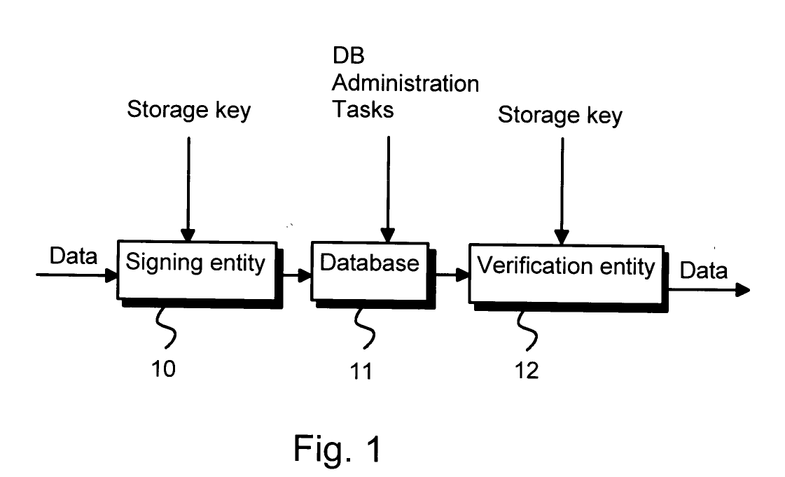

FIG. 1 discloses a flow chart illustrating the basic principle of integrity verification. According to FIG. 1 input data can be received in any suitable form. However, the invention is most useful in cases in which there are a lot of data entries arriving at a fast pace. Suitable entries can be for example data records of the log files of bank transactions that are typically stored in large databases. These log files must be authentic and they must include every event so that they would be accepted in the court of law if necessary.

According to FIG. 1 data arrives to a signing entity 10. Signing entity 10 has its own administrator with authorization to sign data records. Signing may be in the form of digital signature, encryption, or one-way hash. In this description, signing refers to the process of computing a checksum and attaching the computed checksum to the data record. Later on a signing key is referred to as a storage key that may be any type of signing key. On the other hand, it might be useful to use traditional public key encryption method to allow including the name of the signatory to each signed record. The key may be inserted to the system similarly as in secure mailing systems in which the key comprises a secret key file and a secret password part that is typed to the encryption device. The key may also be inserted with a smart card or similar or with any other suitable device.

The method according to the invention signs each data record with an integrity checksum that is computed from the data record to be signed, an integrity checksum of the previous record and the storage key. The computed integrity checksum is then attached to the data record. It may be attached to the data itself or a database 11 may contain a separate field for the integrity checksum. As the computed integrity checksum depends on the previous integrity checksum, it is not possible to remove one or more lines from the middle of the records without breaking the integrity, as the complete chain of integrity checksums is needed for verification. Signed data with integrity checksums will be stored on database 11. Database administrator may perform various tasks to stored data, but he/she cannot change the contents of the data nor remove data records secretly.

The verification of the integrity of consequent data records is performed similarly as signing. A verification entity 12 computes an integrity checksum based on the data record to be signed, a previous integrity checksum and storage key. The computed integrity checksum is then compared to the checksum stored on database 11. If the checksums are not equal, the database has been changed and it is not authentic. The method is beneficial as the integrity of a data record can be checked rapidly without a need to check the integrity of whole database. Verification can be started at any point in the stream of consecutive data records. It should be noted, that the authenticity of the record from which the previous integrity checksum is retrieved cannot be guaranteed. Thus, the verification process must be initiated by retrieving the integrity checksum of the data record previous to the data record to be verified.

If public key cryptography is used for signing, the signing authority signs records in signing entity 10 with his/her private key. The key may be created for signing for a specific database and may be shared with a trusted group having an authorization for signing. In the verification of the integrity the public key of the signing authority is used for decrypting the checksum.

There are different ways for starting the database. An initialization vector may be used instead of a previous integrity checksum for the first row of the database, as there is no previous integrity checksum available. The first row may include actual data or data related to the initialization. For example, an initialization vector may comprise information relating to the initialization, such as date, and the digital signature of a responsible person as a checksum. Thus, there is a previous checksum for the first real data record. The initialization vector or row may be applied also in the middle of the database to allow arranging the data into blocks. Arranging data into blocks does not change the verification procedure.

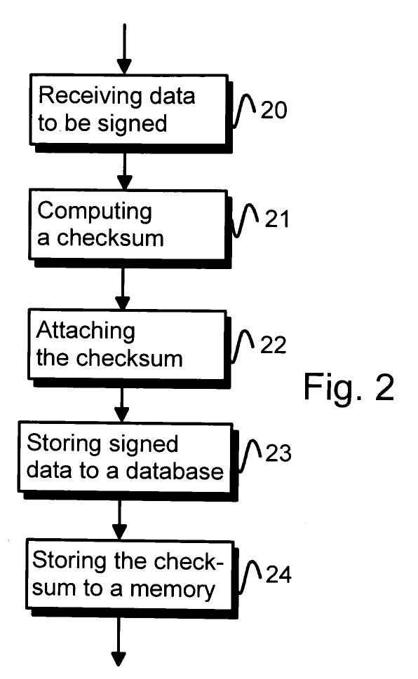

FIG. 2 illustrates a flow chart of one embodiment of storing a data record. At step 20 the data is received from any suitable information system. The data is similar as in embodiment according to FIG. 1. After receiving the data an integrity checksum is computed at step 21. The integrity checksum may be computed with a desired commonly known method as disclosed in the embodiment according to the FIG. 1. The integrity checksum is computed based on the previous checksum, which refers to the checksum attached to the previous data record, the data to be signed and the storage key. Only persons having authorization to sign data records know the storage key. Previous checksum is read from the memory of the signing device. If the integrity checksum is always read from a database, a malicious database administrator may delete the last row of the database without any problems, as the chain of the integrity checksums will not break. There is also other means for ensuring the authenticity of the last row, for example having a running sequence number as a part of the checksum parameters.

The data record is signed by attaching the computed integrity checksum to the data record as illustrated at step 22. The signed data will be stored on the database. The database may contain separate fields for the data and the integrity checksum. The database may also contain additional information fields that may also be used for computing the integrity checksum, for example name of the signatory. After storing the data on the database, the integrity checksum is stored on a memory of the signing device, as illustrated at step 24. This is to ensure that the previous integrity checksum to be used later does not change once it has been computed.

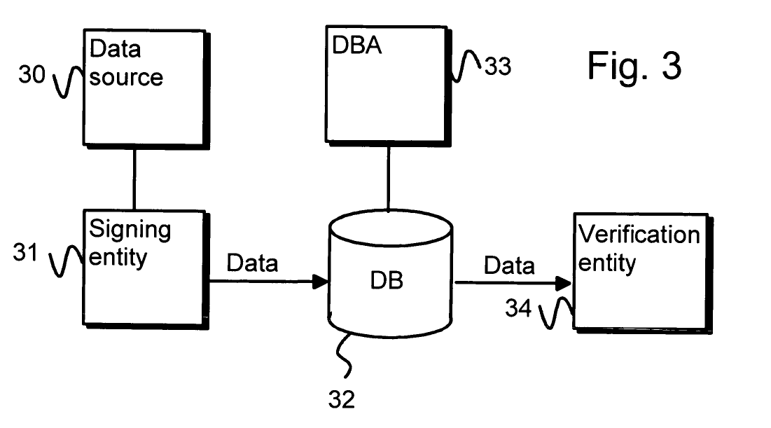

FIG. 3 illustrates a block diagram of one embodiment according to the invention. In FIG. 3 all components have been disclosed separately, but it is obvious to a person skilled in the art that components may be implemented also in the form of a computer program. The system functions according to the method presented in FIG. 2. Thus, the functionality is not described in detail.

The system according to the invention comprises a data source 30, a signing entity 31, a database 32, a database administration console 33 and a verification entity 34. Data source 30 may be any information system that produces data that needs to be stored on database 32. Signing entity 31 is for example a computer program running in a computer that is connected to database system 32 or a program module in database system 32. Database 32 and database administration console 33 may be any general-purpose database system, such as the Oracle database system. Verification entity 34 is similar to signing entity 31. If public key infrastructure is used, signing entity 31 has the secret key and verification entity 34 has the corresponding public key

It is obvious to a person skilled in the art that with the advancement of technology, the basic idea of the invention may be implemented in various ways. The invention and its embodiments are thus not limited to the examples described above; instead they may vary within the scope of the claims.

1. A method for storing data records on a database system in which a signing entity is used for signing data records, the method comprising:
receiving a second data record to be stored on a database;
retrieving a first integrity checksum stored with a first data record previous to the second data record;
computing a second integrity checksum for the second data record with a cryptographic method based on a storage key, the retrieved first integrity checksum and the second data record; and
storing the second data record and the second integrity checksum on the database.

2. The method according to claim 1, wherein the storage key is a secret key of public key infrastructure.

3. The method according to claim 1, wherein the retrieved integrity checksum for a first row of the database is a generated initialization vector.

4. The method according to claim 1, wherein the retrieved integrity checksum for a first row of the database is a digital signature of the signing entity.

5. The method according to claim 1, wherein the first integrity checksum is retrieved from a memory of a signing entity.

6. The method according to claim 1, wherein the second integrity checksum is stored on a memory of the signing entity.

7. The method according to claim 1, wherein the integrity checksums comprise a running sequence number.

8. A method for verifying integrity of data records on a database in which a verification entity is used for verifying integrity of data records, the method comprising:
retrieving a second data record to be verified from a first database;
retrieving a second integrity checksum of the second data record;
retrieving a first integrity checksum of a first data record previous to the retrieved second data record;
computing a third integrity checksum for the second data record based on the retrieved second data record, the first integrity checksum, and a storage key; and
comparing the second integrity checksum to the third integrity checksum, wherein the second data record is considered authentic if the second integrity checksum and the third integrity checksums are equal.

9. The method according to claim 8, wherein the storage key is a public key of public key infrastructure.

10. The method according to claim 8, wherein the retrieved integrity checksum for a first row of the database is a generated initialization vector.

11. The method according to claim 8, wherein the retrieved integrity checksum for a first row of the database is a digital signatory of the signing authority.

12. The method according to claim 8, wherein the first integrity checksum is retrieved from a memory of a verification entity.

13. The method according to claim 8, wherein the second integrity checksum is stored on a memory of a verification entity.

14. The method according to claim 8, wherein the integrity checksums comprise a running sequence number.

15. A system for storing data records on a database system in which a signing entity is used for signing data records and a verification entity is used for verifying integrity of data records, wherein the system comprises:
a database configured to store and provide signed data;
a data source configured to provide data records to be stored on the database system;
a signing entity configured to sign data records to be stored on the database system with a second integrity checksum computed based on a second data record, a first integrity checksum of the first data record previous to the second data record to be signed, and a storage key; and
a verification entity configured to verify integrity of chosen data records by computing a computed third integrity checksum based on the second data record, the first integrity checksum of the first data record previous to the second data record, and the storage key, and comparing the computed third integrity checksum to the second integrity checksum stored on the database.

16. The system according to claim 15, wherein the signing entity and verification entity apply public key infrastructure for calculating and verifying the one of the first integrity checksum and the second integrity checksum.

17. A computer program embodied on a computer readable medium, said computer program for storing data records on a database system in which a signing entity is used for signing data records, wherein the computer program performs the following steps when executed in a computer device:
receiving a second data record to be stored on a database;
retrieving a first integrity checksum stored with a first data record previous to the second data record;
computing a second integrity checksum for the second data record with a cryptographic method based on a storage key, the retrieved first integrity checksum and the second data record; and
storing the second data record and the second integrity checksum on the database.

18. A computer program according to claim 17, wherein the storage key is a secret key of public key infrastructure.

19. A computer program according to claim 17, wherein the retrieved integrity checksum for a first row of the database is a generated initialization vector.

20. A computer program according to claim 17, wherein the retrieved integrity checksum for a first row of the database is a digital signatory of the signing entity.

21. A computer program according to claim 17, wherein the first integrity checksum is retrieved from a memory of the signing entity.

22. A computer program according to claim 17, wherein the second integrity checksum is stored on a memory of the signing entity.

23. A computer program according to claim 17, wherein the integrity checksums comprise a running sequence number.

24. A computer program embodied a computer-readable medium for verifying the integrity of data records on a database, wherein the computer program performs the following steps when executed in a computer device:
retrieving a second data record to be verified from a database;
retrieving a second integrity checksum of the second data record to be verified from a database;
retrieving a first integrity checksum of a first data record previous to the retrieved second data record;
computing a third integrity checksum for the second data record based on the retrieved second data record, the first integrity checksum, and a storage key; and
comparing the second integrity checksum to the third integrity checksum, wherein the second data record is considered authentic if the second integrity checksum and the third integrity checksums are equal.

25. A computer program according to claim 24, wherein a storage key is a public key of public key infrastructure.

26. A computer program according to claim 24, wherein the retrieved integrity checksum for a first row of the database is a generated initialization vector.

27. A computer program according to claim 24, wherein the retrieved integrity checksum for a first row of the database is a digital signatory of a signing authority.

28. A computer program according to claim 24, wherein the first integrity checksum is retrieved from a memory of a verification entity.

29. A computer program according to claim 24, wherein the second integrity checksum is stored on a memory of a verification entity.

30. A computer program according to claim 24, wherein the integrity checksums comprise a running sequence number.
